(19) United States
(12) Patent Application Publication
(10) Pub. No.: US 2024/0233505 A1
(43) Pub. Date: Jul. 11, 2024

(54) PROVISION METHOD AND PROVISION DEVICE FOR ANOMALY INFORMATION

(71) Applicant: TOYOTA JIDOSHA KABUSHIKI KAISHA, Toyota-shi (JP)

(72) Inventors: Yuta MORI, Urayasu-shi (JP); Bing XUE, Tokyo-to (JP); Norimasa KOBORI, Tokyo-to (JP); Takuya MATSUYAMA, Kariya-shi (JP)

(73) Assignee: TOYOTA JIDOSHA KABUSHIKI KAISHA, Toyota-shi (JP)

(21) Appl. No.: 18/532,274

(22) Filed: Dec. 7, 2023

(30) Foreign Application Priority Data
Jan. 11, 2023 (JP) 2023-002137

(51) Int. Cl. G08B 21/02; G06V 10/77; G06V 20/54

(52) U.S. Cl. CPC G08B 21/0233; G06V 10/7715; G06V 20/54; G08B 21/0272; G08B 21/0283

(57) ABSTRACT

In a first example, a user himself/herself sets an area in which the user desires to observe an observation target, a content of an anomaly state of the observation target that the user desires to be notified of, and a sensitivity of the notification of the user with respect to the content. When a state of the observation target corresponds to the anomaly state, occurrence information on the anomaly state is notified to a pre-registered user terminal. In a second example, the user himself/herself sets the area, a content of an anomaly relation between the observation target and a moving object around the observation target that the user wants to be notified of, and the sensitivity. When a relation between the observation target and the surrounding moving object corresponds to the anomaly relation, occurrence information on the anomaly relation is notified to a pre-registered user terminal.

### CROSS-REFERENCE TO RELATED APPLICATION

The present application claims priority under 35 U.S.C. § 119 to Japanese Patent Application No. 2023-002137, filed on Jan. 11, 2023, the contents of which application are incorporated herein by reference in their entirety.

### TECHNICAL FIELD

The present disclosure relates to a method and a device for providing to a user anomaly information in an image of an infrastructure camera.

### BACKGROUND

JP6530856B discloses a system for watching children. This related art executes monitoring process for a child as a watching target. The monitoring process is executed when an observation condition designated by a parent (e.g., a guardian of a child) who has registered the watching target is satisfied. The observation condition includes a geographical condition and a temporal condition. An example of the geographical condition is that the watching target has left a controlled area such as a site of an elementary school. An example of the temporal condition is that the current time is in a school attendance time zone at the elementary school.

In the related art, during the execution of the monitoring process, in addition to positional information on the watching target, the positional information on surrounding persons around the watching target is acquired. In addition, based on a distance between the surrounding person and the watching target, a person (a related person) who acts together with the watching target by the surrounding person is specified. When the related person is specified, a familiarity density between the related person and the watching target is calculated based on the history of the positional information on the related person and the history of the watching target. Then, a safety indicator indicating that the watching target is in the safe condition is calculated based on the presence or absence of the related person and the familiarity with the related person. A notification to the parent is performed based on the safety indicator.

In addition to JP6530856B, JP2007-264913A and JP2019-040575A can be exemplified as documents indicating a technical level elated to the present disclosure.

In the related art, when the safety indicator is lower than a threshold, it is judged that the watching target is not in the safe condition. That is, when the safety indicator is lower than the threshold, it is judged that the watching target is in an anomaly state, and the parent is notified. However, a sensitivity for judging that a certain state of the watching target corresponds to the anomaly state varies among individuals. For this reason, a problem is assumed in which a notification is made to the parent even though the watching target himself/herself feels that it is in the safe condition. In the related art, the parent is notified, whereas the watching target is not notified. Therefore, for example, when a danger is approaching to the watching target, it may not be possible to notify the watching target who is necessary to grasp the danger immediately.

An object of the present disclosure is to provide a technique capable of increasing the convenience of a service for providing to a user anomaly information included in an image captured by an infrastructure camera.

### SUMMARY

A first aspect of the present disclosure is a method for providing to a user anomaly information included in an image of an infrastructure camera, and has the following features.

The method comprising the steps of:
specifying a target camera indicating the infrastructure camera from which the anomaly information is detected;
recognizing a moving object included in an image of the target camera;
when an observation target is included in the moving object, predicting a present or future state of the observation target based on recognition information on the observation target;
judging whether the present or future state corresponds to a preset anomaly state; and when it is judged that the present or future state corresponds to the anomaly state, notifying a pre-registered user terminal occurrence of information on the anomaly state.

In the step of specifying the target camera, area information for specifying the target camera and judgment information for judging whether the present or future state corresponds to the anomaly state in the step of judging the anomaly state are set in association with the observation target.

A second aspect of the present disclosure is a method for providing to a user anomaly information included in an image of an infrastructure camera, and has the following features.

The method comprising the steps of:
identifying a target camera indicating the infrastructure camera from which the anomaly information is detected;
recognizing a moving object included in an image of the target camera;
when an observation target and a surrounding moving object of the observation target are included in the moving object, predicting a present or future relation of the moving objects based on recognition information on the observation target and the surrounding moving object;
judging whether the present or future relation corresponds to a preset anomaly relation; and
notifying occurrence information on the anomaly relation to a pre-registered user terminal when it is judged that the present or future relation corresponds to the anomaly relation.

In the step of specifying the target camera, area information for specifying the target camera and judgment information for judging the present or future relation in the step of judging the anomaly relation are set in association with the observation target.

A third aspect of the present disclosure is a device for providing to a user anomaly information included in an image of an infrastructure camera, and has the following features.

The device includes a processor configured to execute various processing.

The processor is configured to execute processing to:
identify a target camera indicating the infrastructure camera from which the anomaly information is detected;
recognize a moving object included in an image of the target camera;
when an observation target is included in the moving object, predict a present or future state of the observation target based on recognition information on the observation target;
judge whether the present or future state corresponds to a preset anomaly state; and
when it is judged that the present or future state corresponds to the anomaly state, notify a pre-registered user terminal of occurrence information on the anomaly state.

In the processing to specify the target camera, area information for specifying the target camera and judgment information for judging that the present or future state corresponds to the anomaly state in the processing to judge the anomaly state are set in association with the observation target.

A fourth aspect of the present disclosure is a device for providing to a user anomaly information included in an image of an infrastructure camera, and has the following features.

The device includes a processor configured to execute various processing.

The processor is configured to execute processing to:
identify a target camera indicating the infrastructure camera from which the anomaly information is detected;
recognize a moving object included in an image of the target camera;
when an observation target and a surrounding moving object of the observation target are included in the moving object, predicting a present or future relation of the moving objects based on recognition information on the observation target and the surrounding moving object;
judging whether the present or future relation corresponds to a preset anomaly relation; and
notifying occurrence information on the anomaly relation to a pre-registered user terminal when it is judged that the present or future relation corresponds to the anomaly relation.

In the processing to specify the target camera, area information for specifying the target camera and judgment information for judging the present or future relation in the processing to judge the anomaly relation are set in association with the observation target.

According to the first or third aspect, the area information for specifying the target camera is set in association with the observation target. In addition, the judgment information for judging that the present or future state of the observation target corresponds to the anomaly state is also set in association with the observation target. Therefore, it can be said that there is a degree of freedom in setting area information and judgment information. Therefore, it is possible to increase the convenience of the user who uses the service for providing anomaly information.

According to the second or fourth aspect, the area information for specifying the target camera is set in association with the observation target. Also, the judgment information for judging that the present or future relation between the observation target and the surrounding moving object corresponds to an abnormal relation is also set in association with the observation target. Therefore, similarly to the first or third aspect, it can be said that there is a degree of freedom in setting area information and judgment information. Therefore, it is possible to increase the convenience of the user who uses the service for providing anomaly information.

### BRIEF DESCRIPTION OF DRAWINGS

FIG. 1 is a diagram illustrating an example of an overall configuration of a system for providing anomaly information;

FIG. 2 is a diagram illustrating a configuration example of user information shown in FIG. 1;

FIG. 3 is a flowchart illustrating an example of processing executed when user information is registered or updated;

FIG. 4 is a flow chart illustrating an example of processing executed in a data processing device shown in FIG. 1 and particularly relevant to an embodiment; and

FIG. 5 is a flow chart illustrating an example of processing executed in the data processing device shown in FIG. 1, and particularly relevant to the embodiment.

### DESCRIPTION OF EMBODIMENT

Hereinafter, an embodiment of the present disclosure will be described with reference to the drawings. In the drawings, the same or corresponding parts are denoted by the same reference numerals, and the description thereof will be simplified or omitted.

### 1. Anomaly Information Provision Service

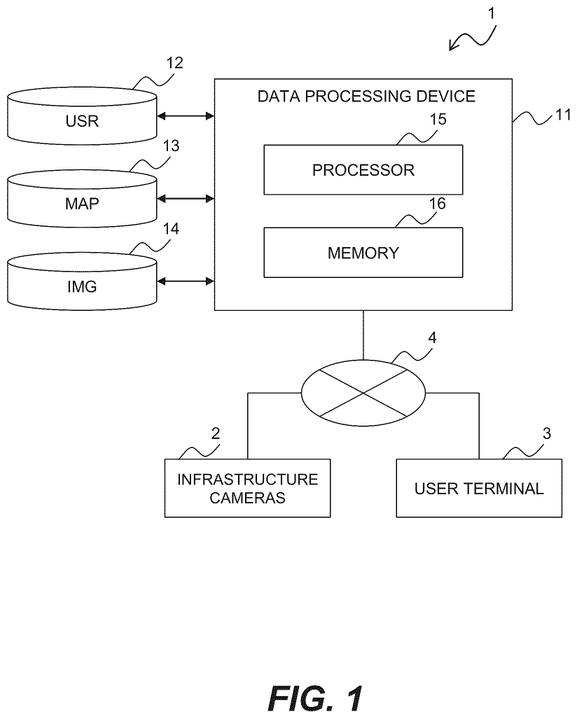

The embodiment is applied to a service for providing to a user anomaly information (hereinafter, also referred to as an “anomaly information provision service”) included in an image of an infrastructure camera. FIG. 1 is a diagram illustrating an example of an overall configuration of a system related to the anomaly information provision service. In the example shown in FIG. 1, the system includes a management server 1, infrastructure cameras 2, and a user terminal 3. The infrastructure cameras 2 and the user terminal 3 communicate with the management server 1 via a communication network 4. The communication network 4 is not particularly limited, and a wired or wireless network may be used.

The management server 1 corresponds to a provision device of the anomaly information according to the embodiment. The management server 1 includes a data processing device 11 and databases 12, 13, and 14. The data processing device 11 includes at least one processor 15 and at least one memory 16. The processor 15 includes a CPU (Central Processing Unit). The memory 16 is a volatile memory such as a DDR memory, and loads various programs used in various processing executed by the processor 15 and temporarily stores various data. The various data used by the processor 15 includes data stored in databases 12, 13, and 14.

The database 12 is formed in a predetermined memory device (e.g., a hard disk or a flash memory). The database 12 stores user information USR. The user information USR is transmitted from the user terminal 3 to the management server 1 via the communication network 4. The user information USR includes identification information on a user UX, identification information on a target (hereinafter also referred to as an “observation target”) TX whom the user UX desires to observe, and the like.

Here, the user UX is a person who uses the anomaly information provision service. The observation target TX is the user UX himself/herself or a person (e.g., a child or an elderly person of the user UX) whom the user UX desires to protect. In the former case, only the user UX uses the anomaly information provision service. On the other hand, in the latter case, persons who use the anomaly information provision service include the user UX and the observation target TX.

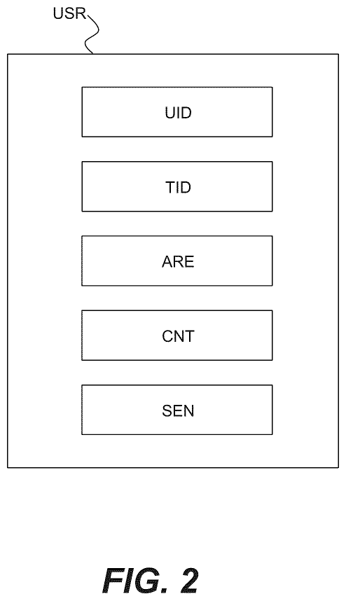

FIG. 2 is a diagram illustrating a configuration example of the user information USR. In the example shown in FIG. 2, the user information USR includes identification information UID of the user UX, identification information TID of the observation target TX, area information ARE, content information CNT, and sensitivity information SEN. The content information CNT and the sensitivity information SEN correspond to “judgment information” of the present disclosure. Note that the sensitivity information SEN includes information that can be set according to the content of the content information CNT and information that cannot be set. Therefore, the sensitivity information SEN which cannot be set may not be included in the user information USR.

In the embodiment, the user UX registers the user information USR when using the anomaly information provision service. When using the anomaly information provision service, the user UX may update part or all the registered data of the user information USR. Examples of the identification information UID include attribute information (e.g., name, sex, and age) of the user UX and identification information on a mobile terminal (typically, the user terminal 3) of the user UX. Examples of the identification information TID include identification information on the mobile terminal of the observation target TX, feature information on the observation target TX (e.g., sex, age, photograph of face or whole-body of the observation target TX, clothes, physique or hair information on the observation target TX), and relation information between the user UX and the observation target TX (e.g., the user UX himself/herself, family, caretaker and care-recipient).

The area information ARE is information on an area in which the user UX desires to observe the observation target TX. The area information ARE is, for example, an area normally used by the observation target TX. Examples of the area normally used by the observation target TX include an area including a route connecting a facility (e.g., a station, a school, or a hospital) normally used by the observation target TX and a home of the observation target TX. The area information ARE may be information on an area other than the area normally used by the observation target TX. Examples of such an area include an area centered on the planned lodging of the observation target TX and an area including a route connecting the planned lodging and a house of the observation target TX.

The content information CNT is, for example, information related to a content indicating an anomaly state (an action, a posture) of the observation target TX, of which the user UX desires to be notified. Examples of the anomaly state include an anomaly state from an aspect on a health maintenance of the observation target TX and an anomaly state from an aspect on a traffic safety of the observation target TX. Examples of the anomaly state from the aspect on the health maintenance include a falling, an aching, a hemorrhage, and an abnormal posture of the observation target TX. Examples of the anomaly state from the aspect on the traffic safety include the falling and the abnormal posture.

Another example of the content information CNT is information related to a content indicating an anomaly relation between the observation target TX and a moving object (e.g., an animal, a person, a bicycle, or a vehicle, hereinafter, also referred to as a “surrounding moving object” STX) in a vicinity of the observation target TX, of which the user US desires to be notified. Examples of the anomaly relation include an anomaly relation from a traffic safety aspect of the observation target TX and an anomaly relation from a crime prevention aspect of the observation target TX. Examples of the anomaly relation from the aspect on the traffic safety include contact and collision between the observation target TX and the surrounding moving object STX. Examples of the anomaly relation from the crime prevention aspect include a chase the observation target TX, an unwanted attention to the observation target TX and an attack on the observation target TX by the surrounding moving object STX.

The sensitivity information SEN is information related to a sensitivity of a notification to the user UX with respect to a content (hereinafter, also referred to as an “ON content”) that the user UX desires to notify among the contents included in the content information CNT. The anomaly state of the observation target TX or the anomaly relation between the observation target TX and the surrounding moving object STX includes a state requiring a notification to the user UX (or the observation target TX) and a state not requiring the notification to the user UX (or the observation target TX). The state requiring the notification to the user UX (or the observation target TX) includes the one needs to be notified immediately and the one needs to be notified but not immediately (e.g., a notification after the fact).

However, there is an individual difference with respect to a boundary between the one requiring the notification and the one not requiring the notification, and a boundary between the one requiring the immediate notification and the one requiring the notification after the fact. It is also conceivable that this boundary changes as a result of several immediate notifications or several notifications after the fact to the user UX (or the observation target TX). Therefore, in the embodiment, the sensitivity information SEN is set as information for adjusting the “sensitivity” indicating the boundary.

The setting of the sensitivity information SEN is performed with respect to an ON content which can be set. For example, consider an example of the fall of the observation target TX. In a case where the observation target TX is an elderly person, it can be said that a small fall of the observation target TX (e.g., a kneeling due to a step on a road) is a state to be watched from the aspect on the health maintenance. Therefore, in this case, it is assumed that the sensitivity information SEN is set to “high”. Then, a small fall of the observation target TX is determined to be the anomaly state.

On the other hand, when the observation target TX is a child, a small fall (e.g., a kneeling without bleeding) is in an allowable range of the fall for the user UX. Therefore, in this case, the sensitivity information SEN for the fall of the observation target TX is set to “low”. Then, a small fall of the observation target TX is not determined to be the anomaly state. It can be said that the bleeding of the observation target TX is not a content for setting the sensitivity information SEN and is a state to be watched from the aspect on the health maintenance regardless of the cause of the bleeding or the amount of the bleeding. Therefore, a small fall accompanied by the bleeding is determined to be the anomaly state.

Consider the case when the observation target TX is a child and this child crouches on the spot after a small fall. In this case, it can be said that the state should be watched from the aspect on the health maintenance. Therefore, in this case, it is assumed that the sensitivity information SEN is set to “middle”. Then, depending on the length of time spent crouching after a small fall of the observation target TX, it will be judged to be in the anomaly state or not.

As a second example, consider an example of approach of the surrounding moving object STX (e.g., a vehicle) around a blind intersection. When the observation target TX is heading toward the blind intersection, it is assumed that the surrounding moving object STX is present around the intersection. It can be said that a state in which both moving objects meet at the blind intersection is a state to be watched from the aspect on the traffic safety. Therefore, in the case where the area information ARE includes information on an area including a blind intersection, when such an encountering is expected at the intersection, it is determined that there is the anomaly relation.

However, there may be a case where the observation target TX is heading toward the blind intersection, but the observation target TX is unlikely to encounter the surrounding moving object STX at this intersection. For example, when the blind intersection is not included in a predicted moving path of the surrounding moving object STX, or when a predicted time at which the surrounding moving object STX arrives at the blind intersection greatly deviates from that of the observation target TX, a probability of the encountering is low. In the second example, the sensitivity information SEN is set according to the probability of the encountering. It is assumed that the user UX who considers that the notification is necessary only when the probability of encountering is high sets the sensitivity information SEN to “low”. It is assumed that the user UX who considers that notification is necessary although the probability of encountering is low sets the sensitivity information SEN to “high”.

Returning to FIG. 1, the description of the configuration example of the system is continued. Like the database 12, the database 13 is formed in a predetermined memory device. The database 13 stores map data MAP. The map data MAP includes data related to specifications of artificial objects such as buildings, roads, and railways (e.g., type, size, latitude, longitude, and height of a central position or one or more representative positions) and data related to specifications of natural objects such as rivers, lakes, and marshes. The map data MAP further includes data relating to specifications of each infrastructure camera constituting the infrastructure cameras 2. The data related to the specifications of the infrastructure camera may include information on a static object (e.g., an artificial object such as a building) included in a view angle of the infrastructure camera.

Like the database 12, the database 14 is formed in a predetermined memory device. The database 14 stores image data IMG. The image data IMG is data of an image acquired by the infrastructure cameras 2. The image data IMG is combined with identification information on the infrastructure camera specified by data related to specifications of the infrastructure camera and information on acquisition time of the image data. The image data IMG is typically moving image data, but may be still image data.

The infrastructure cameras 2 includes a plurality of infrastructure cameras. The plurality of infrastructure cameras may include not only an infrastructure camera installed outdoors but also an infrastructure camera installed indoors. Some or all of view angles of the two or more infrastructure cameras may overlap. Each infrastructure camera acquires image data IMG. Each infrastructure camera also transmits the acquired image data IMG to the management server 1 via the communication network 4.

The user terminal 3 is a terminal (e.g., a smartphone or a tablet) carried by the user UX. The mobile terminal of the user UX is used, for example, when registering or updating the user information USR by the user UX. Occurrence information on the anomaly state of the observation target TX is notified to the user terminal 3. Alternatively, the occurrence information on the anomaly relation between the observation target TX and the surrounding moving object STX is notified to the user terminal 3. The user terminal 3 to which the occurrence information is notified includes not only a mobile terminal of the user UX but also a terminal (e.g., a smartphone, a tablet, or a wearable device) carried by the observation target TX.

### 2. Processing Example on User Terminal Side

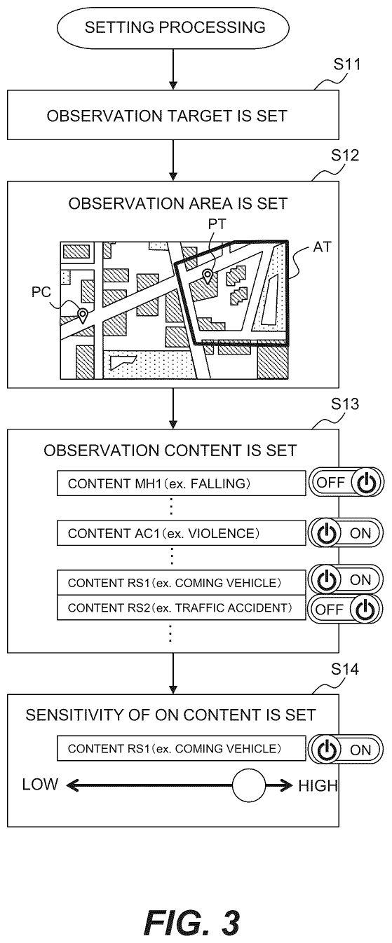

FIG. 3 is a flow chart illustrating an example of setting processing executed in the mobile terminal (the user terminal 3) of the user UX when registering or updating the user information USR. When this processing is executed, it is assumed that a program for the anomaly information provision service is executed by a processor of the mobile terminal of the user UX.

In the example shown in FIG. 3, first, the observation target is set (step S11). In the processing of step S11, for example, options including “principal” and “other than principal” are displayed on a screen of the mobile terminal of the user UX.

When “principal” is selected, the observation target is the user UX. In this case, the user UX registers feature information on the user UX (e.g., gender, age, face and whole-body photographs of the user UX, and information on clothes, physique, and hair of the user UX). The information on the set feature information on the user UX is associated with identification information UID of the user UX other than this information (e.g., attribute information on the user UX, identification information on the mobile terminal of the user UX), and is stored in the database 12 as the identification information TID of the observation target TX.

When “other than principal” is selected, the user UX registers relation information between the user UX and the observation target TX (e.g., family, caretaker and care-recipient), identification information on the mobile terminal of the observation target TX, and feature information on the observation target TX (e.g., gender, age, face and whole-body photographs of the observation target TX, clothes, physique and hair information on the observation target TX). These set pieces of information are associated with the identification information UID of the user UX other than these pieces of information, and are stored in the database 12 as the identification information TID of the observation target TX.

After the observation target is set, the observation area is set (step S12). In the processing of step S12, for example, a map around the actual position PC of the user UX is displayed on the screen of the mobile terminal of the user UX. On the map around the actual position PC, the user UX performs an operation to surround an area where the observation target TX is desired to be observed. Thus, the observation area AT is set. The observation area AT may be an area normally used by the observation target TX or an area other than the area normally used by the observation target TX. The information on the set observation area AT is associated with the observation target TX set in the processing of step S11, and stored in the database 12 as the area information ARE.

In another example of step S12, on the map displayed on the screen of the mobile terminal, the user UX performs an operation to set a position PT at which the observation target T X is desired to be observed and set a circular or rectangular around the position PT. Thus, the observation area AT is set.

In the example shown in FIG. 3, a map around the actual position PC of the user UX is depicted. However, in the processing of step S12, when the user UX designates an arbitrary position on the map, a map around the arbitrary position may be displayed. In this case, the user UX performs an operation to surround an area in which the observation of the observation target TX is desired on the map around an arbitrary position. Alternatively, the user UX performs an operation to set a position PT at which the observation of the observation target TX is desired and set a circular or rectangular region around the position PT. Thus, the observation area AT is set at the arbitrary position where the user UX desires to observe the observation target TX.

After the observation area is set, an observation content is set (step S13). In the processing of step S13, for example, a list including a content MH1, . . . related to the health maintenance, a content AC1, . . . related to the crime prevention, and a content RS1, . . . related to the traffic safety is displayed on the screen of the mobile terminal of the user UX. A button for switching between ON and OFF of the setting is displayed next to each content. The user UX performs a moving operation of the button displayed beside each content while viewing the list, and selects the content desired to be notified.

In the example shown in FIG. 3, contents AC1 and RS1 are selected as the contents for which the notification is desired, and contents MH1 and RS2 are selected as the contents for which notification is not desired. The information on the observation content set to ON is associated with the observation target TX set in the processing of step S11 and stored in the database 12 as the content information CNT.

After the setting of the observation content, the sensitivity of the ON content is set (step S14). In the processing of step S14, for example, a bar for setting the sensitivity of the ON content is displayed below the ON content. The user UX performs a moving operation of the button displayed on the setting bar to set the sensitivity. In the example shown in FIG. 3, the sensitivity of the content RS1 related to traffic safety is set to a “high” level. The information on the set observation content is associated with the sensitivity set in the processing of step S13 and stored in the database 12 as the sensitivity information SEN.

### 3. Processing Example on Management Server Side

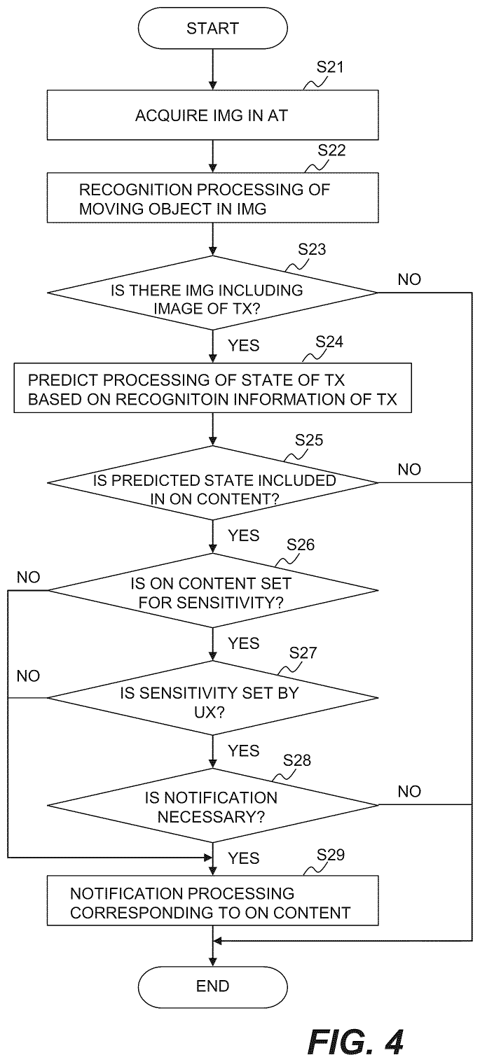

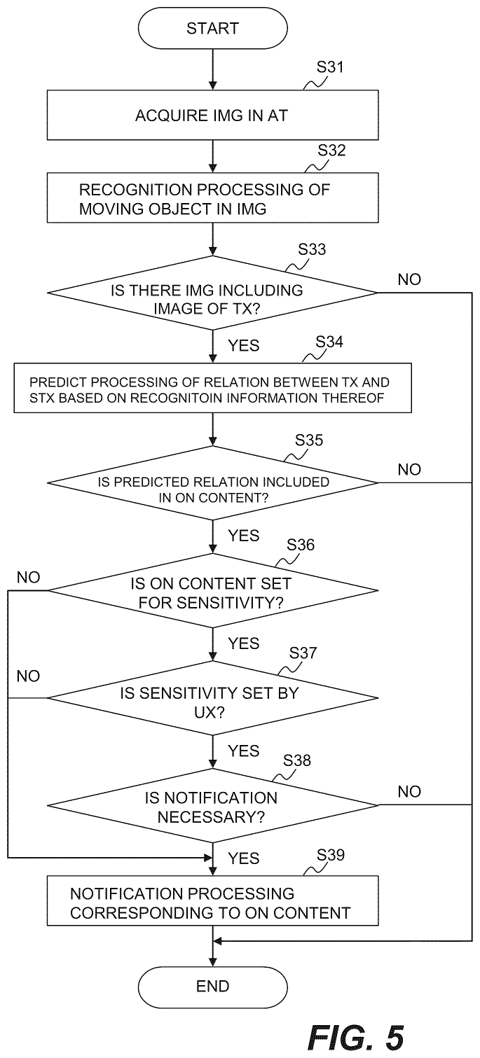

FIGS. 4 and 5 are flowcharts showing an example of processing executed in the data processing device 11 shown in FIG. 1 and particularly relevant to the embodiment. When this processing is executed, the program for the anomaly information provision service is executed by the processor 15 shown in FIG. 1. The processing of the routines shown in FIGS. 4 and 5 is repeatedly executed at a predetermined cycle.

The execution of the processing of the routines shown in FIGS. 4 and 5 starts and ends when the data processing device 11 receives an observation command from the user terminal 3, for example. The observation command may include a date and a time zone for performing observation of the observation target TX. In this case, the processing of the routines shown in FIGS. 4 and 5 is executed on the designated date and time zone.

In the routine shown in FIG. 4, first, the image data IMG in the observation area AT is acquired (step S21). In the processing of step S21, for example, the infrastructure camera existing in the observation area AT is specified based on the area information ARE for the observation target TX and the map datum MAP. Then, the image data IMG acquired by the specified infrastructure camera is read from the database 14. Hereinafter, the infrastructure camera from which the image data IMG is read is also referred to as a “target camera”.

In a second example of the processing of step S21, the infrastructure camera existing in the observation area AT is specified based on the area information ARE for the observation target TX and the map information MAP. Up to this point, it is the same as the above-described first example. In the second example, positional information on the observation target TX is obtained. The positional information on the observation target TX is acquired as, for example, the positional information on the mobile terminal of the observation target TX. Then, based on the positional information, the target camera is narrowed down from among the infrastructure cameras existing in the observation area AT.

As an area of the observation area AT increases, an amount of data of the image data IMG increases. In this regard, if the target camera is narrowed down based on the positional information on the observation target TX, it is possible to reduce processing load with regard to processing executed thereafter.

Following the processing of step S21, recognition processing of the moving object included in the image data IMG is executed (step S22). In the processing of step S22, a moving object included in the image data IMG is recognized by using the image data IMG acquired in the processing of step S21. For example, a known image recognition technique based on machine learning and a person identification technique included in a plurality of images having different acquisition times are applied to the recognition processing of the moving object. Training data of the machine learning includes at least the feature information on the observation target TX. Therefore, if the image data IMG includes the image of the observation target TX, the observation target TX can be recognized by this image recognition. If the observation target TX can be recognized once, the observation target TX can be tracked by person identification.

Following the processing of step S22, it is judged whether there is image data IMG including the image of the observation target TX (step S23). If the judgment in step S23 is negative, the current processing is terminated. When the judgement result of step S23 is positive, the processing of step S24 is executed.

Before the execution of the processing in step S24, the narrowing down may be performed such that only the infrastructure camera that has acquired the image data IMG including the image of the observation target TX is set as the target camera. Alternatively, the narrowing down may be performed in which the infrastructure camera that has acquired the image data IMG including the image of the observation target TX and infrastructure cameras locating around the same infrastructure camera are set as the target cameras. This is because if the target camera is narrowed down, processing load with regard to processing executed thereafter is reduced.

In the processing of step S24, a state (a motion, a posture) of the observation target TX is predicted based on the recognition information on the observation target TX. In the processing of step S24, the present or future state of the observation target TX is predicted based on the recognition information on the observation target TX. For example, a known image recognition technology based on machine learning is applied to the prediction processing of the state of the observation target TX. In this prediction processing, the present or future state of the observation target TX is predicted from the aspect on the health maintenance and the aspect on the traffic safety.

Following the processing of step S24, it is determined whether the state of the observation target TX predicted in the processing of step S24 is included in the state corresponding to the ON content (step S25). In the processing of step S25, it is first judged whether the predicted state of the observation target TX obtained by the processing of step S24 is the anomaly state. A known image recognition technique based on machine learning is applied to this judgement. For example, feature information corresponding to the anomaly state is applied to training data of machine learning. Then, it is possible to detect that the state of the observation target TX predicted in the processing of step S24 is the anomaly state.

When it is detected that the state of the observation target TX predicted in the processing of step S24 is the anomaly state, it is determined whether the detected anomaly state is included in the state corresponding to the ON content based on the content information CNT. If the judgement result is negative, current processing is ended. On the other hand, when the judgement result is positive, the processing of steps S26 to S28 is executed.

The processing from step S26 to step S28 is processing to consider the individual difference in the sensitivity of the observation target TX to the anomaly state. In the processing in step S26, it is judged whether the ON content set as the judgment target in step S25 is the content for which sensitivity is to be set. When the judgement result of step S27 is negative, that is, when it is judged that the ON content is the content other than the target of setting of the sensitivity, the processing of step S29 is executed. Details of the processing of step S29 will be described later.

When the judgement result of step S26 is positive, the processing of step S27 is executed. In the processing of step S27, it is judged whether the sensitivity is set by the user UX. For example, a default setting of the sensitivity is set to the “high” level, and it is judged whether the sensitivity of the ON content is at the “high” level based on the sensitivity information SEN. Then, when the sensitivity of the ON content has been changed to a level other than the “high” level, it can be determined that the sensitivity is set. When it is judged that the sensitivity of the ON content is at the “high” level, the processing of step S29 is executed.

When the judgement result of step S27 is positive, the processing of step S28 is executed. In the processing of step S28, it is judged whether the notification with respect to the anomaly state of the observation target TX is necessary. The processing of step S28 is executed based on the sensitivity information SEN. For example, when the sensitivity of the ON content is set to a level other than the “high” level, it is judged whether the notification is necessary based on the set level of the sensitivity and the state of the observation target TX predicted in the processing of step S24. When it is determined that the notification is necessary, the processing of step S29 is executed.

In the processing of step S29, notification processing corresponding to the ON content is executed. In this notification processing, information indicating that the anomaly state of the observation target TX corresponding to the ON content has occurred is transmitted to the user terminal 3. As described above, examples of the anomaly state of the observation target TX include the anomaly state from the aspect on the health maintenance of the observation target TX and the anomaly state from the aspect on the traffic safety of the observation target TX. Therefore, the user terminal 3 notifying the anomaly state of the observation target TX is assumed to be a mobile terminal of the user UX such as a family member or a care-recipient of the observation target TX. Therefore, in the notification processing, the user terminal 3 to which the occurrence information on the anomaly state is notified is determined based on the content of the ON content.

The processing of the routine shown in FIG. 5 is basically the same as that described with reference to FIG. 4. The difference between the two drawings is that while the object of notification in the routine shown in FIG. 4 is the anomaly state of the observation target TX, that in FIG. 5 is the anomaly relation between the observation target TX and the surrounding moving object STX. Therefore, in the following description, the difference between the two drawings will be described, and the description of the matching point will be simplified.

In the routine shown in FIG. 5, first, processing from step S31 to step S33 is executed. The processing from step S31 to step S33 is basically the same as the processing from step S21 to step S23 described with reference to FIG. 4. In the processing of step S32, in order to recognize and track the observation target TX and the surrounding moving object STX, a known image recognition technique based on machine learning and a technique for identifying a moving object included in a plurality of images having different acquisition times are applied.

When the judgement result of step S33 is positive, the processing of step S34 is executed. In the process of step S34, the present or future relation between the observation target TX and the surrounding moving object STX is predicted based on the recognition information on the observation target TX and the surrounding moving object STX. The above-described image recognition technology and moving object identification technology are applied to the prediction processing of the relation between the two moving objects. In this prediction processing, the present or future relation between the observation target TX and the surrounding moving object STX is predicted from the traffic safety aspect and the crime prevention aspect.

Following the processing of step S34, it is judged whether the relation between the observation target TX and the surrounding moving object STX predicted in the processing of step S34 is included in the relation corresponding to the ON content (step S35). If the judgement result in step S35 is negative, the current processing is ended. When the judgement result of step S35 is positive, the processing from step S36 to step S38 is executed. The processing from step S36 to step S38 is basically the same as the processing from step S26 to step S28 described with reference to FIG. 4.

In the processing of step S39, the notification processing corresponding to the ON content is executed. In this notification processing, information indicating that the anomaly relation between the observation target TX and the surrounding moving object STX corresponding to the ON content has occurred is transmitted to the user terminal 3. As described above, examples of the anomaly relation between the observation target TX and the surrounding moving object STX include an anomaly relation from the aspect on the traffic safety and the anomaly relation from the aspect on the security. Therefore, the user terminal 3 notifying the anomaly relation between the observation target TX and the surrounding moving object STX is assumed to be a mobile terminal of a person whom the user UX desires to protect and a mobile terminal of the user UX as the observation target TX. Therefore, in the notification processing, the user terminal 3 to which the occurrence information on the anomaly relation is to be notified is determined based on the content of the ON content.

### 4. Effect

According to the embodiment described above, it is possible for the user UX to set the area in which the user UX desires to observe the observation target TX, the content of the anomaly state of the observation target TX to which the user UX desires to be notified, and the sensitivity of the notification of the user UX to the content. Alternatively, it is possible for the user UX to set the area in which the user UX desires to observe the observation target TX, the content of the anomaly relation between the observation target TX and the surrounding moving object STX to which the user UX desires to be notified, and the sensitivity of the notification of the user UX to the content. That is, according to the embodiment, it is possible to increase the degree of freedom in setting information necessary for the observation of the observation target TX. Therefore, it is possible to increase the convenience of the user UX using the anomaly information provision service.

According to the embodiment, further, it is also possible to set the sensitivity of the notification of the user UX to the content of the anomaly state of the observation target TX or the content of the anomaly relation between the observation target TX and the surrounding moving object STX. Therefore, it is possible to notify only information desired by the user UX in consideration of individual differences in sensitivity to the anomaly state or the relation. This will lead to a further improvement in convenience.

According to the embodiment, further, the notification destination of the occurrence information on the anomaly state or the relation is further determined in accordance with the content of the anomaly state of the observation target TX or the content of the anomaly relation between the observation target TX and the surrounding moving object STX. Therefore, it is possible to notify necessary information to a person who should be notified of an anomaly state or a relation. This also will lead to a further improvement in convenience.

What is claimed is:

1. A method for providing to a user anomaly information included in an image of an infrastructure camera, the comprising the steps of:
specifying a target camera indicating the infrastructure camera from which the anomaly information is detected;
recognizing a moving object included in an image of the target camera;
when an observation target is included in the moving object, predicting a present or future state of the observation target based on recognition information on the observation target;
judging whether the present or future state corresponds to a preset anomaly state; and when it is judged that the present or future state corresponds to the anomaly state, notifying a pre-registered user terminal occurrence of information on the anomaly state,
wherein, in the step of specifying the target camera, area information for specifying the target camera and judgment information for judging whether the present or future state corresponds to the anomaly state in the step of judging the anomaly state are set in association with the observation target.

2. The method according to claim 1,
wherein the anomaly state includes a state in which the present or future state is recognized as an anomaly from an aspect on a traffic safety or a health maintenance,
wherein the judgment information set in association with the observation target includes information related to a content indicating the anomaly state and information related to a sensitivity of notification for the content.

3. The method according to claim 1,
wherein the user terminal includes a mobile terminal of the observation target,
wherein the judgment information set in association with the observation target includes information related to a content indicating the anomaly state,
wherein, in the step of notifying the occurrence information to the user terminal, the user terminal to which the occurrence information is notified is determined based on the content indicating the anomaly state.

4. The method according to claim 1,
wherein the observation target is a preset person,
wherein, in the step of specifying the target camera, the target camera is specified based on the area information set in association with the observation target, the positional information on the infrastructure camera, and the positional information on the observation target,
wherein, in the step of recognizing the moving object, the observation target is recognized based on feature information on the observation target.

5. A method for providing to a user anomaly information included in an image of an infrastructure camera, the comprising the steps of:
identifying a target camera indicating the infrastructure camera from which the anomaly information is detected;
recognizing a moving object included in an image of the target camera;
when an observation target and a surrounding moving object of the observation target are included in the moving object, predicting a present or future relation of the moving objects based on recognition information on the observation target and the surrounding moving object;
judging whether the present or future relation corresponds to a preset anomaly relation; and
notifying occurrence information on the anomaly relation to a pre-registered user terminal when it is judged that the present or future relation corresponds to the anomaly relation,
wherein, in the step of specifying the target camera, area information for specifying the target camera and judgment information for judging the present or future relation in the step of judging the anomaly relation are set in association with the observation target.

6. The method according to claim 5,
wherein the anomaly relation includes a relation in which the present or future relation is recognized as being anomalous from a traffic safety or security aspect,
wherein the judgment information set in association with the observation target includes content information related to a content indicating the anomaly relation and sensitivity information related to a sensitivity of the notification for the content.

7. The method according to claim 5,
wherein the user terminal includes a mobile terminal of the observation target,
wherein the judgment information set in association with the observation target includes content information related to a content indicating the anomaly relation,
wherein, in the step of notifying the occurrence information to the user terminal, the user terminal to which the occurrence information is notified is determined based on the content indicating the anomaly relation.

8. The method according to claim 5,
wherein the observation target is a preset person,
wherein, in the step of specifying the target camera, the target camera is specified based on the area information set in association with the observation target, the positional information on the infrastructure camera, and the positional information on the observation target,
wherein, in the step of recognizing the moving object, the observation target is recognized based on feature information on the observation target.

9. A device for providing to a user anomaly information included in an image of an infrastructure camera, comprising a processor configured to execute various processing,
wherein the processor is configured to execute processing to:
identify a target camera indicating the infrastructure camera from which the anomaly information is detected;
recognize a moving object included in an image of the target camera;
when an observation target is included in the moving object, predict a present or future state of the observation target based on recognition information on the observation target;
judge whether the present or future state corresponds to a preset anomaly state; and
when it is judged that the present or future state corresponds to the anomaly state, notify a pre-registered user terminal of occurrence information on the anomaly state,
wherein, in the processing to specify the target camera, area information for specifying the target camera and judgment information for judging that the present or future state corresponds to the anomaly state in the processing to judge the anomaly state are set in association with the observation target.
